(19) United States
(12) Patent Application Publication
(10) Pub. No.: US 2018/0040155 A1
(43) Pub. Date: Feb. 8, 2018

(54) CACHE FRIENDLY JITTERED HEMISPHERICAL SAMPLING

(71) Applicant: THOMSON Licensing, Issy-ies-Moulineaux (FR)

(72) Inventors: Pascal LECGCG, SAINT GREGOIRE (FR); Arthur DUFAY, Chantepie (FR); Jean-Eudes MARViE, BETTON (FR)

(21) Appl. No.: 15/549,378

(22) PCT Filed: Feb. 5, 2016
(86) PCT No.: PCT/EP2016/052444

§ 371 Date: Aug. 7, 2017

(30) Foreign Application Priority Data
Feb. 10, 2015 (EP) 15305189.1

(51) Int. Cl. G06T 15/06; G06T 7/277; G06T 15/50

(52) U.S. Cl. CPC G06T 15/06; G06T 15/50; G06T 7/277

(57) ABSTRACT

An Apparatus for use in producing lighting effects comprising a plurality of graphic processing units, each graphic processing unit for jittering a first ray, having a direction, to result in a second ray, the second ray having a direction not the same as the first ray; and each graphic processing unit having a plurality of threads for processing rays for computing lighting effects such that the first ray is processed by a first thread and the second ray is processed in a thread adjacent to the first thread; and a memory for providing data for use in computing the lighting effects for the first ray and the second ray.

### BACKGROUND OF THE INVENTION

The present invention relates to the domain of image generation, or rendering, in the representation of three-dimensional scenes and concerns the efficiency of processing for rendering realistic lighting effects.

The rendering of realistic lighting effects in movie production requires proper simulation of full light exchanges in a scene by taking into account all direct and indirect lighting contributions. As known in the art, the challenging task involves solving the rendering equation representing the integral of all lighting contributions reaching a surface that are scattered in all directions (e.g., see K. J. T, “The Rendering Equation,” ACM SIGGRAPH Computer Graphics, no. 143-150, 1986). Solving the rendering equation is not trivial, no analytic solution exists. Stochastic ray tracing methods such as Path tracing or Photon Mapping are usually employed to fully or partially solve the equation (e.g., see K. J. T, “The Rendering Equation,” ACM SIGGRAPH Computer Graphics, no. 143-150, 1986; and H. W. Jensen, “Global Illumination using Photon Maps,” Proceedings of the Seventh Eurographics Workshop on Rendering, pp. 21-30, 1996).

These ray tracing methods require many ray intersection evaluations with exponential complexity involving many hours of computation on many core CPUs (central processing units). With recent advances in massive parallel GPUs (graphic processing units) new computing solutions have emerged allowing reduced computation time and some interactive rendering with some quality tradeoff. They rely on dedicated spatial acceleration structures such as BVH (bounding volume hierarchy) and LBVH (linear bounding volume hierarchy) that maps very well on GPU memory with good locality of data.

More specifically, efficient GPUs for ray-tracing applications rely on the SIMD (Single Instruction Multiple Data) parallel programming model (the term SIMD being referred to here as covering SIMT as well, for Single Instruction Multiple Thread). Typically, then, a GPU instantiates a kernel program such as a ray intersection, on a grid of parallel thread blocks. Each thread block is assigned to a multiprocessor that concurrently execute the same kernel in smaller blocks called warps. Threads within a block have access to a shared first-level cache memory, or L1 cache, while threads across thread blocks are sharing a slightly slower shared second-level cache memory, or L2 cache.

In the frame of ray tracing, the processing of pixels in images is grouped by means of thread blocks, allowing multiple rays to be evaluated in parallel across pixels of the image utilizing the L1 cache and L2 cache. However, when a thread requests data from a texture, or a buffer, not available in the associated L1 cache or L2 cache (a cache miss), the GPU must then take the time to prefetch a new cache block, thereby again making local memory data available for other threads in the same block (L1 cache) or the same warp (L2 cache). As such, locality of data accessed by a group of threads in a block or in a warp therefore appears key for good data bandwidth. In other words, scattered data accesses, i.e., severe cache misses, lead to poor performance.

In particular, stochastic GPU ray tracing techniques commonly used to solve the rendering equation partition a camera image into a block of threads, where each thread computes the illumination of a pixel of the image by Monte Carlo integration. The Monte Carlo integration consists in tracing secondary rays randomly distributed on the hemisphere surrounding a point on a surface. However, parallel tracing of unorganized rays in a block of threads leads to severe cache misses due to scattered BVH data access. Since each ray/thread in a block can access a random space region, concurrent threads can't take advantage of prefetching (caching) due to random BVH node fetches. This situation represents a serious bottleneck with direct impact on rendering performances.

### SUMMARY OF THE INVENTION

In accordance with the principles of the invention, a novel sampling strategy improves GPU cache efficiency, i.e., reduces cache misses, without any tradeoff on image quality in performing ray tracing.

In this respect, the present disclosure relates to a graphics processing device configured to participate in rendering at least one image including a set of pixels and representing a 3D (three dimensional) scene. The 3D scene includes surface elements having light interaction features, each of the pixels being constructed from light contributions corresponding to rays coupling that pixel and the surface elements in function of at least those light interaction features.

Therefore, and in accordance with the principles of the invention, we propose a novel approach to randomly sample the hemisphere surrounding a point in a way to minimize GPU cache misses for secondary rays. This approach is based on a per pixel random jittering of a unique stochastic hemisphere sampling. Our solution provides a better sampling distribution compared to rotation based solution, removes the spatial noise and drastically improves rendering performances by maintaining a good GPU cache coherency.

In an illustrative embodiment of the invention, an apparatus for use in producing lighting effects comprises a plurality of graphic processing units, each graphic processing unit for jittering a first ray, having a direction, to result in a second ray, the second ray having a direction not the same as the first ray; and each graphic processing unit having a plurality of threads for processing rays for computing lighting effects such that the first ray is processed by a first thread and the second ray is processed in a thread adjacent to the first thread; and a memory for providing data for use in computing the lighting effects for the first ray and the second ray.

In another illustrative embodiment of the invention, a method for use in producing lighting effects comprises jittering a secondary ray having a direction to result in a corresponding jittered ray, the jittered ray having a direction not the same as the secondary ray; thread processing the secondary ray in a first thread; and thread processing the jittered ray in a thread adjacent to the first thread.

In view of the above, and as will be apparent from reading the detailed description, other embodiments and features are also possible and fall within the principles of the invention.

### BRIEF DESCRIPTION OF THE DRAWINGS

FIG. 1 shows an illustrative graphics processing apparatus in accordance with the principles of the invention;

FIG. 2 shows an illustrative block diagram of a GPU in accordance with the principles of the invention;

FIG. 3 illustrates the parallel computing and memory management functionalities of the GPUs shown in FIGS. 1 and 2;

FIG. 4 illustrates the scattering of secondary rays in a scene, representative of a situation to be processed by the graphics processing apparatus of FIG. 1;

FIG. 5 illustrates the scattering of an incoming ray on a perfectly diffuse surface, to be processed by the graphics processing apparatus of FIG. 1;

FIG. 6 represents a sampling distribution corresponding to the perfectly diffuse surface of FIG. 5;

FIG. 7 illustrates the parallel processing of scattered secondary rays in a scene, failing the use of the graphics processing apparatus of FIG. 1;

FIGS. 8, 9, 10 and 11 illustrate the parallel processing of scattered secondary rays in a scene in accordance with the principles of the invention, with the use of the graphics processing apparatus of FIG. 1; and

FIG. 12 shows three tables illustrating performance results.

### DETAILED DESCRIPTION

Other than the inventive concept, techniques used in stochastic ray tracing, e.g., the rendering equation, Path tracing, Photon tracing, Lambert's law and Monte Carlo techniques are well known and not described herein (e.g., see K. J. T, “The Rendering Equation,” ACM SIGGRAPH Computer Graphics, no. 143-150, 1986; and H. W. Jensen, “Global Illumination using Photon Maps,” Proceedings of the Seventh Eurographics Workshop on Rendering, pp. 21-30, 1996). Further, other than the inventive concept, the elements shown in the figures are well known and will not be described in detail. For example, GPUs, warps and thread blocks, etc., are well known and not described in detail herein. Finally, like-numbers on the figures represent similar elements.

As some background, the “coupling” by a ray between a pixel and a surface element means that the ray provides contributions to the image rendering at the pixel, as being originating from the surface element. Those contributions are preferably indirect, the rays being then secondary rather than primary. Also, the term “originating” here is to be understood in its physical and not computational meaning, insofar as the rays are advantageously traced starting from the pixels rather than from the surface elements, in the frame of rendering.

In ray tracing, the computation processing circuits that are used are preferably multiple, and consist advantageously in processing cores of at least one GPU. Their number in each GPU can notably range from a few ones to several hundred (e.g., 300). In particularly appropriate embodiments of the device according to the invention, the computation processing circuits are then exploited for parallel processing of the pixels, a high number of cores being particularly appropriate then.

In such embodiments, as will be familiar to a skilled person, threads are concurrently executing a same kernel in parallel in respective processing cores for respective pixels, each thread being dedicated to a pixel, and the threads are grouped into thread blocks (which can include various numbers of threads) sharing common cache memory. This cache memory is typically an L1 cache.

At a larger scale, thread blocks are grouped into thread grids or thread warps (which can include various numbers of blocks, and thus of threads), local memory data being commonly available to the threads in a same warp. A GPU can include itself several warps, thereby providing potentially as a whole a high number of threads.

For sake of pure illustration, a GPU in an illustrative embodiment comprises 24 multiprocessors each of which capable of concurrently executing 32 threads—which makes 768 threads in the GPU at a time. In another illustrative embodiment, the GPU comprises a unique warp of 512 threads—which amounts to 512 threads in the GPU at a time.

In advantageous embodiments involving GPUs, the latter comprises local memory for per-thread data, and shared memory, including cache memory, such as L1 and L2 caches, for low-latency access to data. The memory resources that are used can be available from any kind of appropriate storage means, which can be notably a RAM (Random Access Memory) or an EEPROM (Electrically-Erasable Programmable Read-Only Memory) such as a Flash memory, possibly within an SSD (Solid-State Disk). According to particular characteristics, the L1 caches are respectively associated with blocks of threads, while L2 caches are respectively associated with warps. According to other characteristics, the L2 caches are globally available for the set of warps in a GPU.

By contrast, additional background memory resources are available external to the GPUs, such as notably in the form of one or several GRAM (Graphics Random Access Memory)—which can be available in a graphics card together with the GPUs. This is subject to higher-latency accesses via buses. The GRAM itself comprises for instance a set of DRAMs.

As such, the less access to GRAM and the better the locality of data with respect to the use of the L1 cache and L2 cache, the quicker the processing operations are for ray tracing. As is apparent from the following description, the graphics processing device in accordance with the principles of the invention is able to offer such a major asset.

In illustrative embodiments, the ray directions exploited in the graphics processing device of the invention are pre-computed random directions for secondary rays, obtained from stochastic or distributed ray tracing.

The ray data representative of ray directions, which are stored in the memory elements of a graphics processing device compliant with the invention, correspond preferably to relative ray directions, with respect to the corresponding surface elements (which is, for each ray direction, the surface element from which the ray having the ray direction is originating, that ray coupling that surface element and the pixel associated with the considered memory element). More precisely, they are advantageously represented by cartesian coordinates within the unit disk on that surface element.

Namely, quite especially in global illumination techniques, the choice of a good sampling for the secondary ray directions is crucial to reduce the variance and obtained reduced noise images. Notably, Monte Carlo methods exploited in stochastic ray tracing use weighted distribution tending to optimal sampling. They take into account Lambert's law for perfect diffuse surfaces and energy lobe in reflection directions for specular surfaces. This leads to sampling distributions to which the following advantageous embodiments are particularly well adapted, though not being limited thereto.

The reference direction depends on the light interaction features of the surface element. In preferred implementations: if the surface is dealt with as perfectly diffuse, the reference direction is given by a normal to the surface element; if the surface is dealt with as specular, the reference direction is given by a reflection direction of an incoming ray; if the surface is dealt with as refractive, the reference direction is given by a refraction direction of an incoming ray.

In particular, most of the sampling distribution resulting from associated Monte Carlo method is oriented towards the normal to the surface element (for diffusion) or the reflected ray (for specular reflection). Preferably, the rays are chosen and processed according to a stochastic ray tracing method, those rays being secondary rays corresponding to indirect illumination in rendering the image, and being spawned from scattering on the surface elements.

As described above, stochastic GPU ray tracing techniques commonly used to solve the rendering equation partition a camera image into a block of threads, where each thread computes the illumination of a pixel of the image by Monte Carlo integration. The Monte Carlo integration consists in tracing secondary rays randomly distributed on the hemisphere surrounding a point on a surface. However, parallel tracing of unorganized rays in a block of threads leads to severe cache misses due to scattered BVH data access. Since each ray/thread in a block can access a random space region, concurrent threads can't take advantage of prefetching (caching) due to random BVH node fetches. This situation represents a serious bottleneck with direct impact on rendering performances.

Therefore, and in accordance with the principles of the invention, we propose a novel approach to randomly sample the hemisphere surrounding a point in a way to minimize GPU cache misses for secondary rays. This approach is based on a per pixel random jittering of a unique stochastic hemisphere sampling. Our solution provides a better sampling distribution compared to rotation based solution, removes the spatial noise and drastically improves rendering performances by maintaining a good GPU cache coherency.

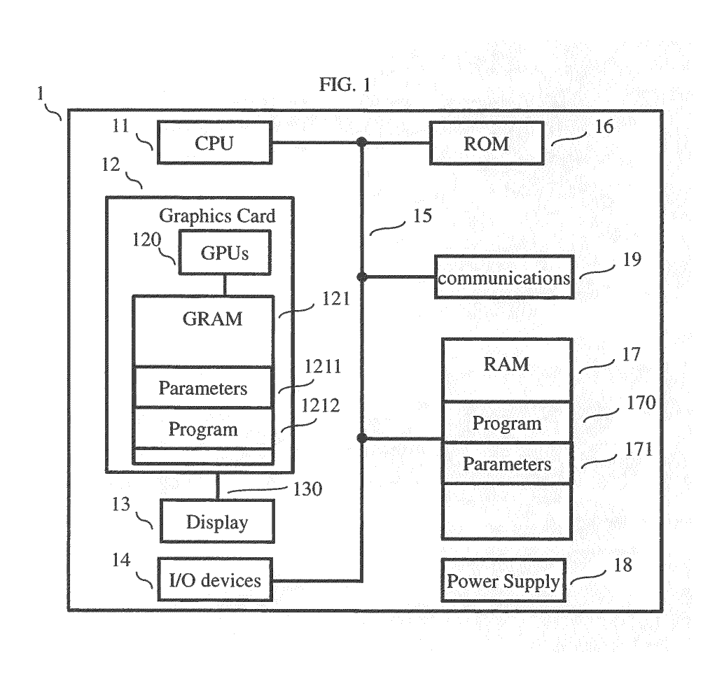

An illustrative apparatus for use in ray tracing in accordance with the principles of the invention is shown in FIG. 1. The apparatus 1 corresponds for example to a personal computer (PC), a laptop, a tablet, a smartphone or a games console—especially specialized games consoles producing and displaying images live. The apparatus 1 comprises the following elements, connected to each other by a bus 15 of addresses and data that also transports a clock signal: a microprocessor 11 (or CPU); a graphics card 12 comprising: several Graphical Processor Units (or GPUs) 120, a Graphical Random Access Memory (GRAM) 121; a non-volatile memory of ROM (Read Only Memory) type 16; a Random Access Memory or RAM 17; one or several I/O (Input/Output) devices 14 such as for example a keyboard, a mouse, a joystick, a webcam; other modes for introduction of commands such as for example vocal recognition are also possible; a power source 18; and a communications 19 (for wired and/or wireless communications, e.g., to a local area network).

The apparatus 1 also comprises a display device 13 of display screen type directly connected to the graphics card 12 to display synthesized images calculated and composed in the graphics card, for example live. The use of a dedicated bus to connect the display device 13 to the graphics card 12 offers the advantage of having much greater data transmission bitrates and thus reducing the latency time for the displaying of images composed by the graphics card. According to a variant, a display device is external to the device 1 and is connected to the apparatus 1 by a cable or wirelessly for transmitting the display signals. The apparatus 1, for example the graphics card 12, comprises an interface for transmission or connection adapted to transmit a display signal to an external display means such as for example an LCD or plasma screen or a video-projector. In this respect, the communications 19 can be used for wireless transmissions.

When switched-on, the microprocessor 11 loads and executes the instructions of the program contained in the RAM 17. The random access memory 17 stores an operating program 170 of the microprocessor 11 responsible for switching on the apparatus 1, and also stores parameters 171 representative of the scene (for example modelling parameters of the object(s) of the scene, lighting parameters of the scene).

The program illustratively implementing the steps of the method specific to the invention and described hereafter is stored in the memory GRAM 121 of the graphics card 12 associated with the apparatus 1. When switched on and once the parameters 171 representative of the environment are loaded into the RAM 17, the graphic processors 120 of the graphics card 12 load these parameters into the GRAM 121 and execute the instructions of these algorithms in the form of microprograms of “shader” type using HLSL (High Level Shader Language) language or GLSL (OpenGL Shading Language) for example.

The random access memory GRAM 121 illustratively stores parameters 1211 representative of the scene, and a program 1212 in accordance with the principles of the invention, as described further below.

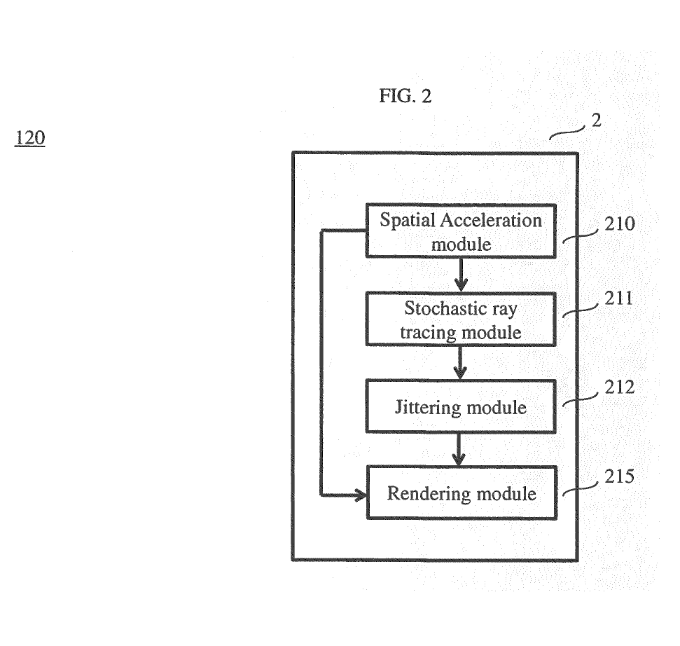

Turning now to FIG. 2, the GPUs 120 are illustrated in more detail. The GPUs 120 can form a distributed GPU ray tracing system, involving GPU computing kernels, and possibly relying on parallel computing architecture such as notably CUDA (Compute Unified Device Architecture), OpenCL (Open Computing Language) or Compute Shaders. One of the GPUs 120, numbered GPU 2 as shown in FIG. 2, includes: a module 210 for spatial acceleration, such as BVH; alternatively, LBVH, BSP trees such as notably k-d trees, or Octrees structures are implemented, several spatial acceleration schemes being possibly available in same GPU 2; a module 211 for stochastic ray tracing, yielding multiple rays having respective ray directions; a module 212 for jittering the rays in accordance with the principles of the invention; and a rendering module 215, proceeding with the final steps of performing ray intersections and adding light contributions scattered towards a viewing direction.

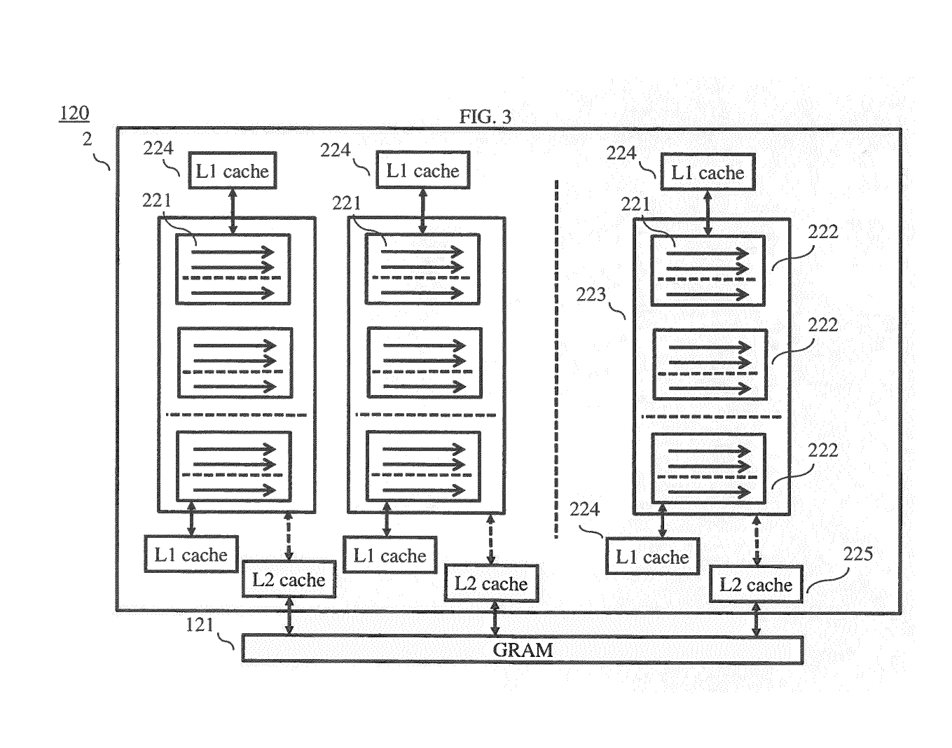

FIG. 3 is more precisely devoted to illustrating the parallel mechanisms implemented in the GPU 2. Blocks 222 of threads 221, respectively dedicated to pixels of an image and executed in parallel by a same kernel, are themselves grouped into warps or grids 223. Each thread 221 is allotted a small local memory (not represented), while the threads 221 of a same block 222 are sharing a first-level cache memory or L1 cache 224. The warps 223 are themselves provided with second-level cache memories or L2 caches 225 through the L1 caches 224, which are communicating with the GRAM 121 via dedicated buses. The access to data contained in L2 caches 225 by the threads 221 across blocks 222 is slightly slower than their access to data in L1 caches 224. Both are however significantly faster than accesses to the GRAM 121.

The GPU 2 is working on the ground of SIMD parallel programming, by instantiating a kernel program on each of the warps 223, such as for instance a ray intersection. This makes the threads 221 execute concurrently this same kernel, which proves particularly well suited for ray-tracing applications.

When a thread 221 request data from a texture or a buffer not available in the L1 or L2 caches, the GPU 2 prefetches a cache block making local memory data available for other threads 221 in the same warp 223. In this respect, and as noted earlier, locality of data accessed by a group of threads 221 in a warp 223 is critical to good data bandwidth, while scattered data accesses affect performances. Tracing secondary unorganized rays through the scenes is, as a general observation, a cause of severe cache misses due to random memory in the BVH, such cache misses being produced by incoherent BVH node fetches.

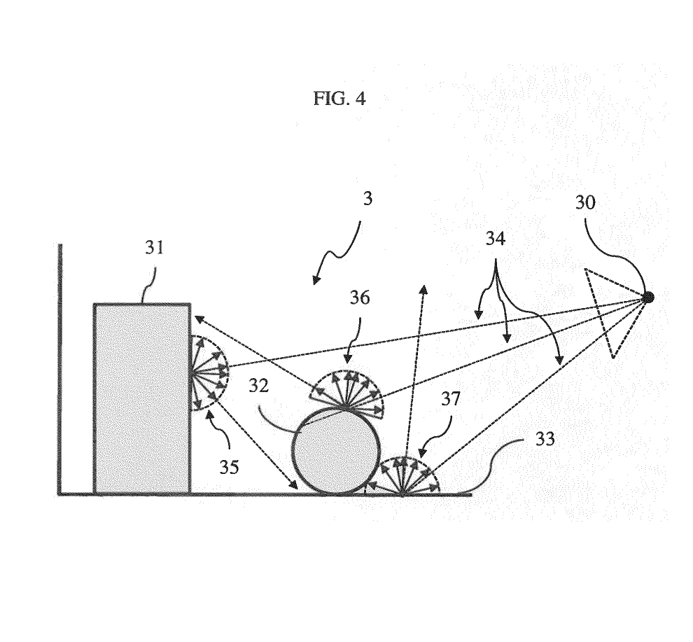

Turning now to FIG. 4, this figure illustratively shows the scattering of primary rays in a scene 3. The latter is viewed from a point of view 30 (also called camera field of view) and corresponds for example to a virtual scene. It comprises several virtual objects, i.e. a first object 31 and a second object 32, further to a ground surface 33—also considered as an object from light interactions prospects. By virtual object is understood any virtual representation (obtained by modelling) of an object (real or fictitious) composing a real environment/real scene (for example the ground, a house or a house front, a person, a car, a tree, that is to say any element composing an environment such as a part of a house, a street, a town, the countryside, etc.) or an imaginary element.

The objects 31 and 32 are modelled according to any method known to those skilled in the art, e.g., by polygonal modelling, in which the model is assimilated with a set of polygons (mesh elements) each defined by the list of summits and edges that compose it, e.g., by NURBS (Non uniform rational basic spline) type curve modelling in which the model is defined by a set of curves created via control vertices, by modelling by subdivision of surfaces.

Each object 31, 32, 33 of the scene 3 is specified by a surface covering it, the surface of each object having scattering features, which can include reflectance properties (corresponding to the proportion of incident light reflected by the surface in one or several directions) and transmittance properties (corresponding to the proportion of incident light transmitted by the surface in one or several directions). The reflectance properties are considered in a broad sense, as encompassing subsurface scattering phenomena (in which light penetrates the surface, is scattered by interacting with the material and exits the surface at a different point).

The present embodiments are focused on reflections, but in other implementations, transmittance is processed alternatively or in combination, the graphics processing apparatus 1 having preferably capacities for both kinds of light interactions with surfaces.

Primary rays 34 coupling the point of view 30 and the surfaces of the objects 31, 32, 33 are rays having potentially a lighting contribution to an image corresponding to this point of view 30. For ray tracing, they are usually processed as originating from the point of view 30 for merely sake of convenient processing, though the contrary is true in the reality—so that the rays 34 are in fact originating from the objects. The rays 34 incoming on the surfaces of the objects 31, 32, 33 are broadly scattered in various directions, leading to incoherent secondary rays, respectively 35, 36 and 37 for objects 31, 32 and 33.

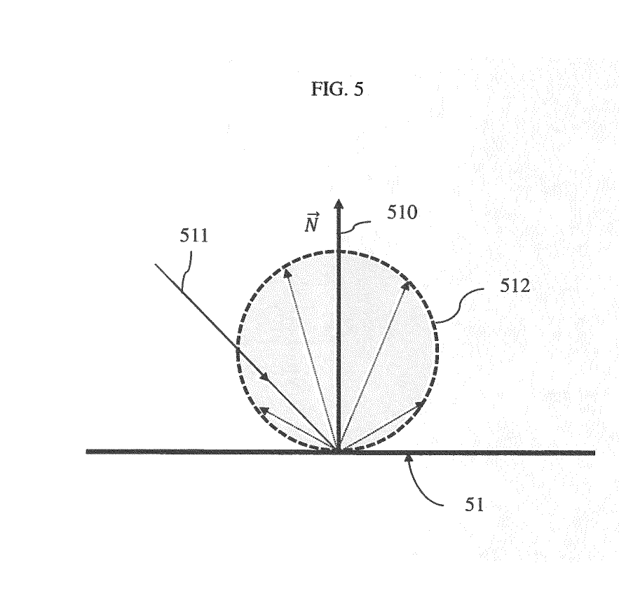

FIG. 5 shows the scattering of an incoming ray 511 on a perfectly diffuse surface 51 having a normal 510, Lambert's law being applicable. Through scattering at the surface 51, rays have a specific well known distribution 512, symmetric with respect to the normal 510 (the luminous intensity being directly proportional to the cosine of the angle between the normal 510 and an observer's line of sight).

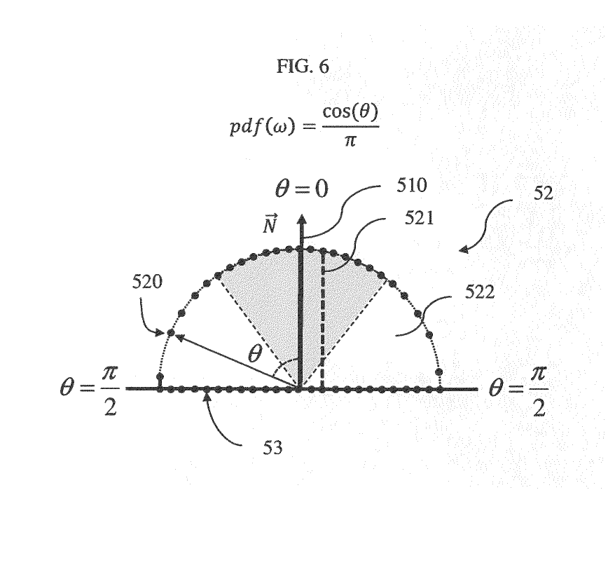

For secondary ray directions generated through a stochastic ray tracing method, as shown in FIG. 6, the Monte Carlo sampling using weighted distribution leads to a sampling distribution 52 of direction samples 520. It appears that the sampling distribution 52 correspond to the vertical projection 521 of a uniform sampling of the unit disk 53 onto the hemisphere.

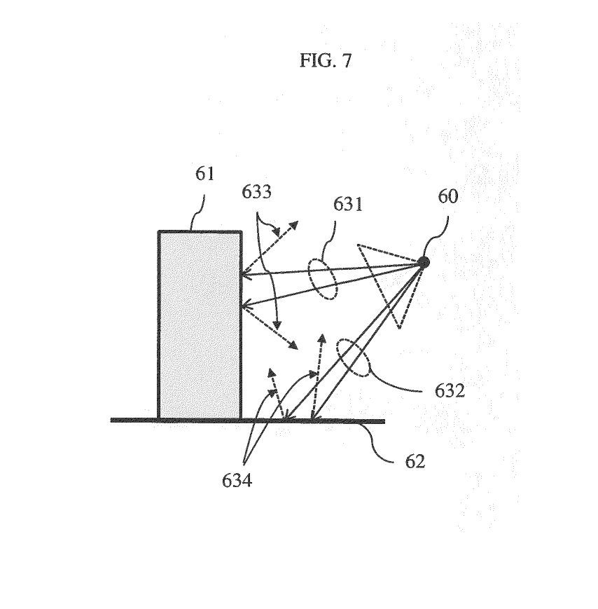

FIG. 7 illustrates the parallel processing of scattered secondary rays in a scene without the principles of the invention. A scene 6 comprising objects 61 and 62 (the ground 62 being here considered as an object) is viewed from a point of view 60. Rays are thus directed to surface elements of those objects 61, 62 from the point of view 60, while forming respective groups of rays 631 and 632 corresponding to respective warps 223 of threads 221. Failing the application of the inventive concept, as visible on FIG. 6, the incoming rays are scattered by the objects 61, 62 into respective reflected rays 633 and 634, in a completely unorganized way causing cache misses. This results in a lack of performance.

Therefore, and in accordance with the principles of the invention, we propose a novel approach to randomly sample the hemisphere surrounding a point in a way to minimize GPU cache misses for secondary rays. This approach is based on a per pixel random jittering of a unique stochastic hemisphere sampling. Our solution provides a better sampling distribution compared to rotation based solution, removes the spatial noise and drastically improves rendering performances by maintaining a good GPU cache coherency.

Samples (normalized ray directions) on the hemisphere are represented by their X and Y coordinates on the unit disk. The Z coordinates is deduced from the sphere equation as follow:

Z=\sqrt{1−X²−Y²} (1)

As shown in FIG. 6, to get a faster estimation of the integral holding the radiance of a pixel (the rendering equation) we use a cosine weighted sampling of the hemisphere surrounding this pixel. This cosine weighted distribution also has a constant Probability distribution function (pdf) (pdf(ω) shown in FIG. 6) which reduces the computation time of the Monte Carlo integrator. The projection of this cosine weighted distribution on a 2D (two dimensional) disk corresponds to a sampling of the unit disk with constant probability density function. To generate such sampling, we consider Poisson disk sampling distribution, due to their inherent minimum distance property between each sample. Note that any other sampling distribution showing a good spatial repartition on the unit disk is also valid.

In accordance with the principles of the invention, given a unique sampling on the unit disk, a 2D vector is randomly chosen to add as an offset (jitter), Δ\vec{ν}, to the sampling. The maximum length of this 2D vector is adaptive. For a Poisson disk sampling the following maximum length is used:

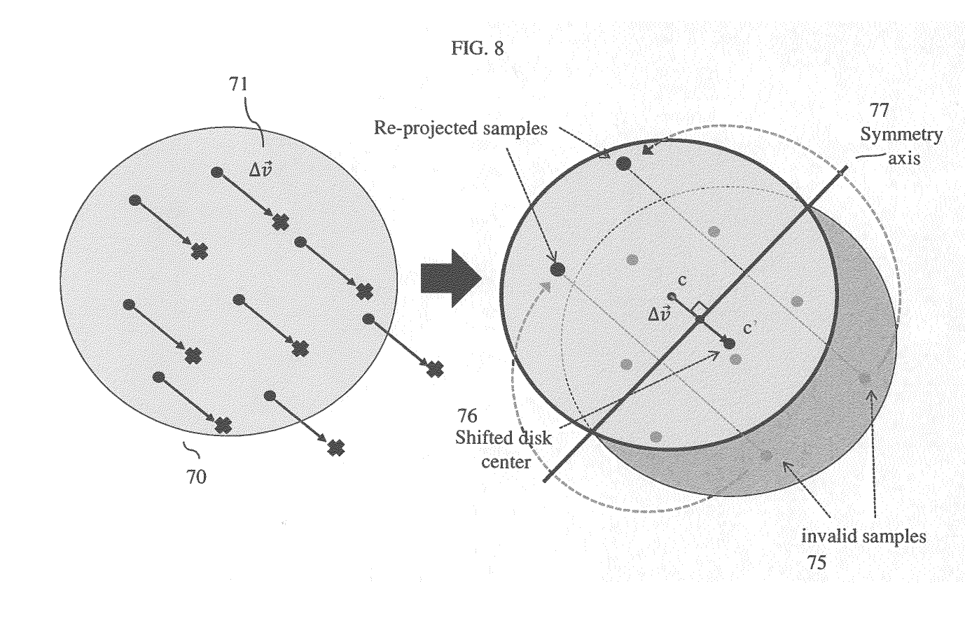

lengthₘₐₓ=r (2)

where r is the minimum distance between each sample of our Poisson disk. For any other distribution, r can be roughly estimated according to sampling density per unit area. FIG. 8 illustrates the jittering of the samples on the unit disk. A unit disk 70 is shown having samples (solid black dots). When jittering the sampling by Δ\vec{ν}, which is 71 as shown in FIG. 8, the samples are jittered, or offset, as shown by the black “X”s. However, as shown in FIG. 8, some resulting samples could be displaced by the jitter outside of the disk resulting in invalid samples 75. In order to keep the same sampling count with similar pdf property, we simply consider the symmetry axis perpendicular to the displacement that goes through the center of cc′ (see 76 in FIG. 8). Invalid samples are then re-projected around this symmetry axis, filling the empty space with valid samples with similar pdf property.

An interesting property of this uniform jittering technique is that it mostly preserves the order of any sorted sampling. For instance, if one considers samples ordered based on their Morton code, a small translation offset mostly preserves the order (except for the rare case of re-projection). Combining the jittered approach with a sorted sampling provides coherent ray traversal among threads executed in a same warp.

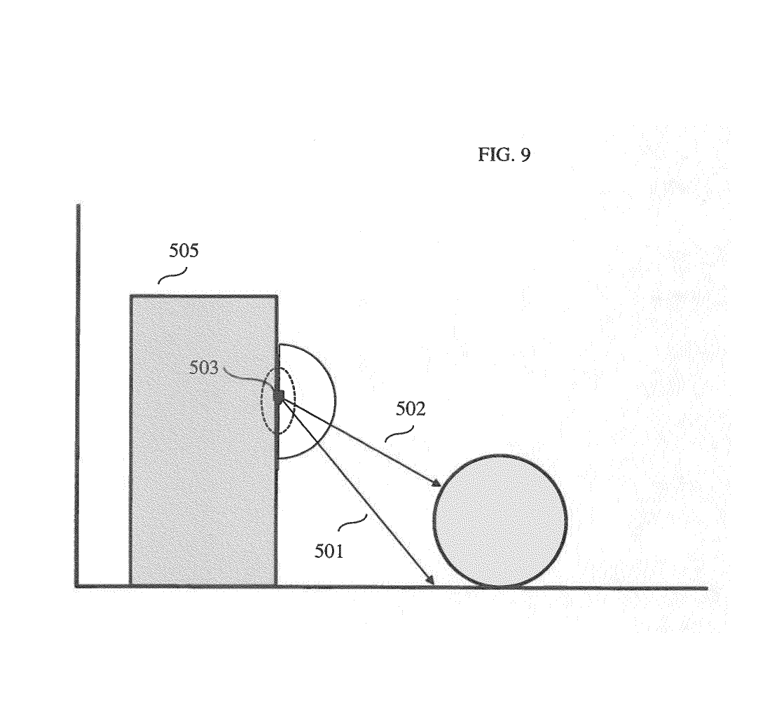

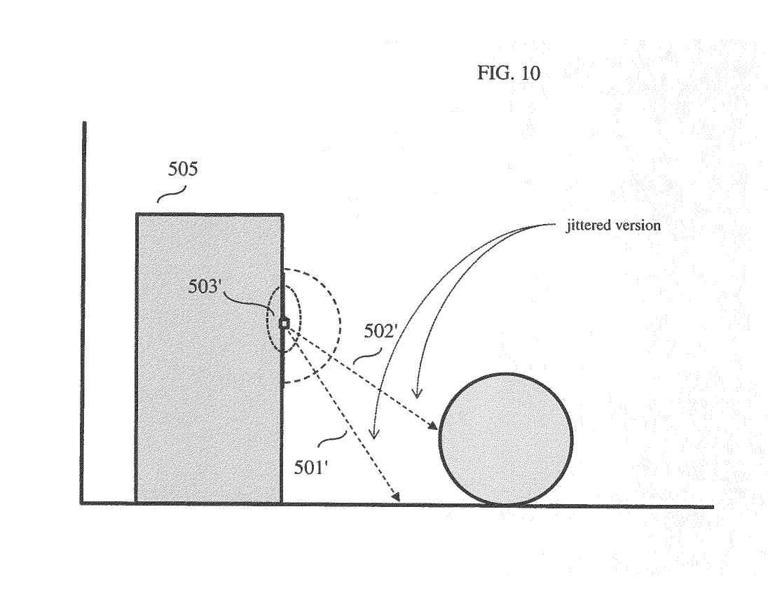

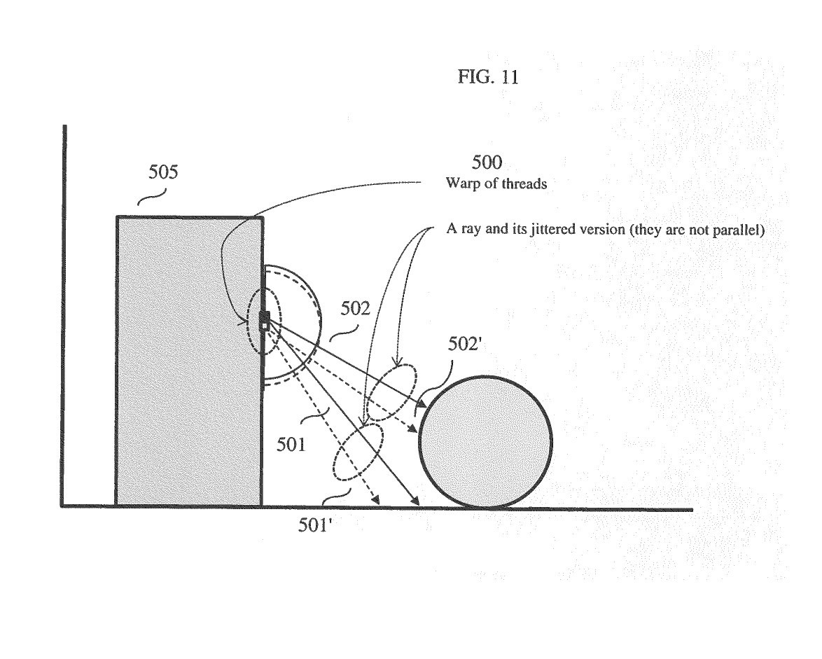

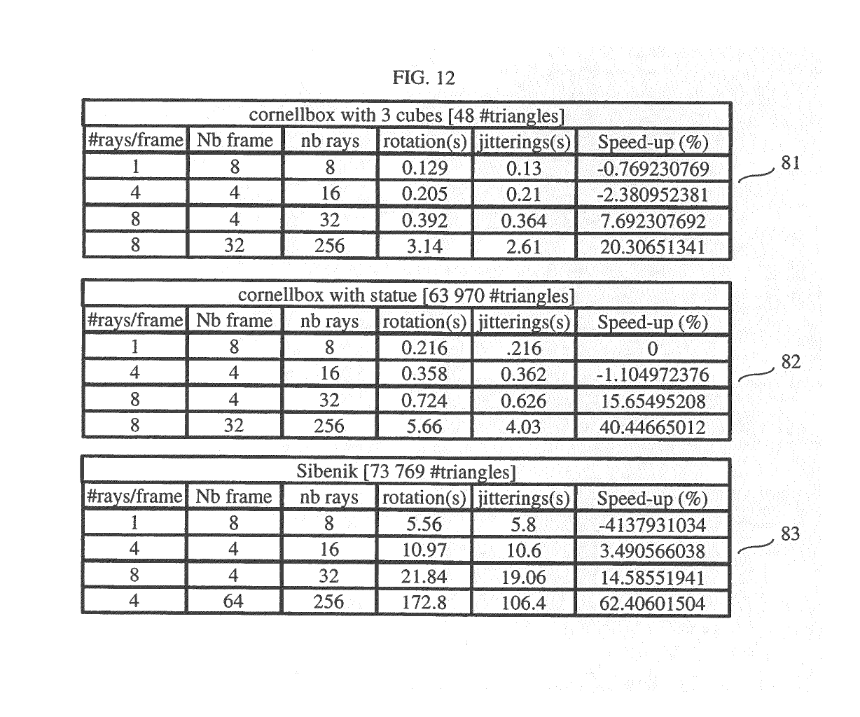

The principles of the invention are further illustrated in FIGS. 9, 10 and 11. In FIG. 9 two secondary rays, 501 and 502, are shown being scattered by object 505 (the primary ray is not shown) at point 503 of object 505. In accordance with the principles of the invention, rays 501 and 502 are then jittered resulting in rays 501′ and 502′ which are now scattered from point 503′ as shown in FIG. 10. FIG. 11 shows the overall result, i.e., the combination of FIGS. 9 and 10. The ray 501 and its jittered version 501′ are processed by the same warp of threads, e.g., warp 223 of FIG. 3. Illustratively, the ray and its jittered version are processed by adjacent threads in warp 223. Likewise for rays 502 and 502′. As such, a ray and its jittered version will hit spatially close geometries but are not parallels. In other words, a ray has a direction and the jittered ray has a direction similar to the ray but not the same as the ray. Since, e.g., ray 501 and 501′ are roughly in the same directions when corresponding to the same, or neighbouring, surface element, this takes advantage of BVH data locality. This results in significantly reducing cache misses at the very first traversal of the BVH. This locality of direction property prevents structured noise artifacts while preserving GPU cache coherency.

FIG. 13 illustrates performance results, which are shown in Tables 81, 82 and 83. These tables show the performance comparisons (in seconds) for the rotation method (e.g., see H. W. Jensen, “Global Illumination using Photon Maps,” Proceedings of the Seventh Eurographics Workshop on Rendering, pp. 21-30, 1996) versus the jittering method for scenes with increasing geometry complexity. These tables clearly show the advantage of the jittering approach when launching several rays in the same frame (up to 62% performance gain (speed-up) as shown in table 83 in the lower right cell). The column headings, going left to right are: number of rays per frame (#rays/frame); number of frames (Nb frame); number of rays (Nb rays); rotation(s); jittering(s) and Speed-up in percent (%).

As described above, and in accordance with the principles of the invention, the hemisphere surrounding a point is randomly sampled in a way to minimize GPU cache misses for secondary rays. This sampling is based on a per pixel random jittering of a unique stochastic hemisphere sampling. This solution provides a better sampling distribution compared to a rotation based solution, removes the spatial noise and drastically improves rendering performances by maintaining a good GPU cache coherency.

The use of the invention is not limited to a live utilisation but also extends to any other utilisation, for example for processing known as postproduction processing in a recording studio for the display of synthesis images for example.

In view of the above, the foregoing merely illustrates the principles of the invention and it will thus be appreciated that those skilled in the art will be able to devise numerous alternative arrangements which, although not explicitly described herein, embody the principles of the invention and are within its spirit and scope. For example, cache friendly jittered hemispherical sampling is applicable to any rendering method based on GPU shaders or computing kernels. It is therefore to be understood that numerous modifications may be made to the illustrative embodiments and that other arrangements may be devised without departing from the spirit and scope of the present invention.

1. A method for image rendering by ray tracing, the method comprising:
generating secondary rays at a first ray intersection associated with a first pixel, said secondary rays having respective directions according to a sampling distribution;
jittering said secondary rays to result in respective corresponding jittered rays at a second ray intersection associated with a second pixel, the jittered rays having directions respectively obtained from the secondary rays by offsetting the directions of the secondary rays;
thread processing one of the secondary rays in a first thread belonging to a group of threads sharing at least one common cache memory; and
thread processing the jittered ray resulting from jittering said one of the secondary rays in a thread corresponding to the same group of threads as the first thread.

2. The method of claim 1, wherein the secondary rays at the first ray intersection associated with the first pixel and the jittered rays at the second ray intersection associated with the second pixel being normalized over a normalized hemisphere, the jittered rays at the second ray intersection associated with the second pixel have normalized directions over said hemisphere respectively obtained from the secondary rays by adding a same offset to projections of the normalized directions of said secondary rays onto a normalized disk corresponding to said normalized hemisphere, resulting in respective offset projections.

3. The method of claim 2, wherein for the normalized disk having a disk center, the jittering step comprises:
when one of said offset projections is outside the normalized disk, re-projecting said one of said offset projections around a symmetry axis of the normalized disk perpendicular to said offset and going through a midpoint of a segment joining said disk center and a shift of said disk center by said offset.

4. The method of claim 1, wherein said group of threads is chosen among a thread block and a group of thread blocks, called a thread warp.

5. (canceled)

6. The method of claim 1, wherein said at least one common cache memory includes a level one cache.

7. An apparatus for image rendering by ray tracing, the apparatus comprising:
at least one graphic processing unit, said graphic processing unit including at least one processor configured for generating secondary rays at a first ray intersection associated with a first pixel, said secondary rays having respective directions according to a sampling distribution, for jittering said secondary rays to result in respective corresponding jittered rays at a second ray intersection associated with a second pixel, the jittered rays having directions respectively obtained from the secondary rays by offsetting the directions of the secondary rays; and said graphic processing unit being adapted to process a plurality of threads for processing rays for computing lighting effects such that one of the secondary rays is processed by a first thread belonging to a group of threads sharing at least one common cache memory and the jittered ray resulting from jittering said one of the secondary rays is processed in a thread corresponding to the same group of threads as the first thread; and
said at least one common cache memory for providing data for use in computing the lighting effects for the secondary ray and the jittered ray.

8. The apparatus of claim 7, wherein said at least one processor is configured for executing the method comprising:
generating secondary rays at a first ray intersection associated with a first pixel, said secondary rays having respective directions according to a sampling distribution;
jittering said secondary rays to result in respective corresponding jittered rays at a second ray intersection associated with a second pixel, the jittered rays having directions respectively obtained from the secondary rays by offsetting the directions of the secondary rays;
thread processing one of the secondary rays in a first thread belonging to a group of threads sharing at least one common cache memory; and
thread processing the jittered ray resulting from jittering said one of the secondary rays in a thread corresponding to the same group of threads as the first thread.

9-12. (canceled)

13. A non-transitory computer-readable medium having computer-executable instructions for a processor-based system such that when executed the processor-based system performs a method for image rendering by ray tracing, the method comprising:
generating secondary rays at a first ray intersection associated with a first pixel, said secondary rays having respective directions according to a sampling distribution;
jittering said secondary rays to result in respective corresponding jittered rays at a second ray intersection associated with a second pixel, the jittered rays having directions respectively obtained from the secondary rays by offsetting the directions of the secondary rays;
thread processing one of the secondary rays in a first thread belonging to a group of threads sharing at least one common cache memory; and
thread processing the jittered ray resulting from jittering said one of the secondary rays in a thread corresponding to the same group of threads as the first thread.

14-15. (canceled)

16. The method of claim 1, wherein said at least one common cache memory includes a level two cache.
